(19) United States
(12) Patent Application Publication
(10) Pub. No.: US 2013/0042551 A1
(43) Pub. Date: Feb. 21, 2013

(54) DEBRIS SCREEN

(71) Applicant: Jamie Dimitris Elias Koutsoukos, Ellenbrook (AU)

(72) Inventor: Jamie Dimitris Elias Koutsoukos, Ellenbrook (AU)

(21) Appl. No.: 13/585,460

(22) Filed: Aug. 14, 2012

(30) Foreign Application Priority Data
Aug. 17, 2011 (AU) 2011 903285

(51) Int. Cl. E06B 3/30; E04B 1/38; E04H 9/14

(52) U.S. Cl. 52/202; 52/741.3; 52/698

(57) ABSTRACT

A support 40 for supporting a barrier 21 for covering an opening of a building comprises a shock absorbing portion 56. The support 40 is attachable relative to the building and is able to support the barrier 21 such that the barrier 21 substantially covers the opening and such that the shock absorbing portion 56 is able to absorb at least some of the energy of an object that impacts the barrier 21.

### FIELD OF THE INVENTION

The present invention relates generally to debris screens and, in particular, to an improved debris screen that is able to withstand higher impact loads.

### BACKGROUND ART

Cyclones generate strong winds that are capable of lifting and propelling loose objects such as debris through the air at high speeds. When this happens the objects essentially become potentially lethal missiles that can kill, injure, or damage anything or anyone that they may strike.

Glass windows and doors are particularly susceptible to being damaged by flying objects during a cyclone. If a glass window or door of a building is struck with sufficient force by a flying object, the glass of the window or door will shatter. The shards of shattered glass can themselves then become potentially lethal missiles that are capable of causing damage, injury, or even death. Also, after shattering the glass, the object may continue on and potentially cause further damage, injury, or death inside the building.

Cyclone debris screens have been developed to protect windows and doors of buildings from being damaged by flying objects during cyclones. They are also able to prevent such objects from entering a building through a window or door.

Existing cyclone debris screens are rigidly fixed screens that transmit the majority of the energy from an object that impacts them to the building that they are attached to. The impact strength of these screens is finite and they fail if they are struck by an object with sufficient energy.

The Australian standard for cyclone debris screens previously required that such screens be capable of withstanding an impact load of at least 400 Joules. Such an impact load on a cyclone debris screen equates to the screen being struck by a test object travelling at a speed of 15 metres per second.

The standard was recently amended to require that some cyclone debris screens be capable of withstanding an impact load of around Joules, i.e. an impact load that is many times greater than the maximum impact load they were previously required to be capable of withstanding.

Existing rigidly fixed cyclone debris screens are not apable of withstanding such high impact loads.

It would therefore be desirable to have a cyclone debris screen that is capable of withstanding the maximum impact load specified in the amended Australian standard mentioned above.

It is against this background that the present invention has been developed.

### SUMMARY OF THE INVENTION

It is an object of the present invention to overcome, or at least ameliorate, one or more of the deficiencies of the prior art mentioned above, or to provide the consumer with a useful or commercial choice.

Other objects and advantages of the present invention will become apparent from the following description, taken in connection with the accompanying drawings, wherein, by way of illustration and example, a preferred embodiment of the present invention is disclosed.

According to a first broad aspect of the present invention, there is provided a support for supporting a barrier for covering an opening of a building, the support comprising a shock absorbing portion, the support being attachable relative to the building and also being able to support the barrier such that the barrier substantially covers the opening and such that the shock absorbing portion is able to absorb at least some of the energy of an object that impacts the barrier.

The support may assist the barrier to withstand an impact from an object that has more energy than the barrier would be able to withstand in the absence of being supported by the support.

Preferably, the support comprises a frame. For example, the support may comprise a frame that is attachable relative to a window or door of the building. In one particular preferred form, the support comprises a mounting frame for supporting a screen that comprises the barrier. In another particular preferred form, the support comprises a screen frame for holding the barrier.

Preferably, the support is attachable relative to the building such that the shock absorbing portion of the support is substantially located between the barrier and the building.

Preferably, the shock absorbing portion comprises a resilient element. For example, the resilient element may comprise a resilient tube or block. Alternatively, the shock absorbing portion may comprise a crumple zone, or the shock absorbing portion may be collapsible,

According to a second broad aspect of the present invention, there is provided a method for protecting a building from an object impact, the method comprising the steps of:

supporting a barrier for covering an opening of the building with a support that comprises a shock absorbing portion; and

attaching the support relative to the building such that the supported barrier substantially covers the opening and such that the shock absorbing portion is able to absorb at least some of the energy of an object that impacts the barrier.

According to a third broad aspect of the present invention, there is provided a debris screen assembly for protecting a building from an object impact, the assembly comprising a barrier for covering an opening of the building, and a support that supports the barrier, the support comprising a shock absorbing portion, the support being attachable to the building such that the barrier substantially covers the opening and such that the shock absorbing portion is able to absorb at least some of the energy of an object that impacts the barrier.

Preferably, the support comprises a mounting frame.

Preferably, the screen assembly also comprises a screen that comprises the barrier and a screen frame that holds the barrier.

Preferably, the debris screen assembly also comprises a latch mechanism that secures the screen to the mounting frame.

Preferably the barrier comprises mesh. The mesh may for example comprise a wire mesh.

Preferably, at least the barrier is able to be hinged relative to the building. Hinging at least the barrier relative to the building can make it easier to clean the barrier, and can also make it easier for a person to enter or exit the building through the opening.

### BRIEF DESCRIPTION OF THE DRAWINGS

In order that the invention may be more fully understood and put into practice, a preferred embodiment thereof will now be described with reference to the accompanying drawings, in which:

FIG. 1 is a cross-sectional side elevation of a portion of a preferred embodiment of a partially disassembled cyclone debris screen assembly;

FIG. 2 is a cross-sectional side elevation of a portion of the fully assembled cyclone debris screen assembly prior to the screen being impacted by an object; and

FIG. 3 is a cross-sectional side elevation of a portion of the fully assembled cyclone debris screen assembly when impacted by an object.

### DESCRIPTION OF EMBODIMENTS

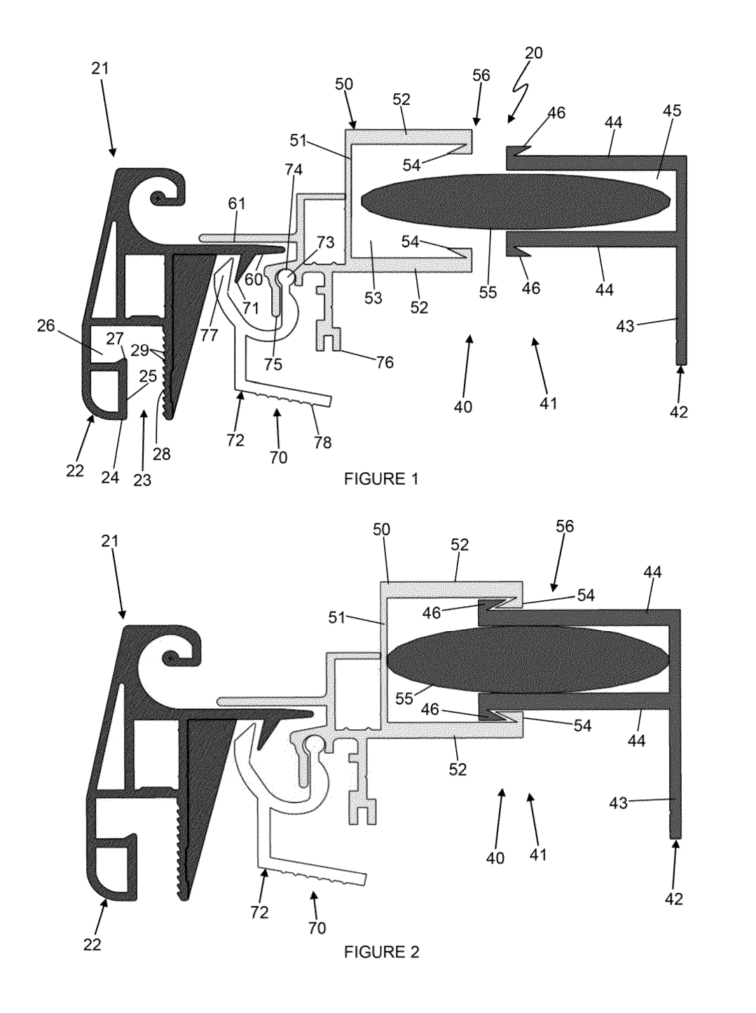

Referring to FIG. 1, there is depicted a cross-sectional side elevation of a fragment of cyclone debris screen assembly 20 for protecting an opening of a building such as for example a window or door of a building from object impacts. The debris screen assembly 20 is able to prevent a windborne object such as windborne debris from impacting a window or door of a building during cyclonic conditions, and is also able to prevent the object from entering the building through the window or door. The assembly 20 is designed to comply with the amended Australian standard for cyclone debris screens that requires that cyclone debris screens be capable of withstanding an impact load of at least 4000 Joules.

The debris screen assembly 20 includes a screen 21. Screen 21 includes a screen frame 22 that forms a perimeter of the screen 21. Although not shown in the figures, the screen frame 22 will typically include a pair of laterally spaced and parallel horizontal elongate frame members and a pair of laterally spaced and parallel vertical elongate frame members that extend between and that are joined to the horizontal frame members so that the frame 22 is substantially rectangular. Screen 21 also includes a barrier (not depicted) of wire mesh that is held by the screen frame 22 and that fills a central void of the screen 21 that is defined by the screen frame 22.

Screen frame 22 includes a recess 23 that extends into the frame 22 from an inner face 24 thereof. Recess 23 receives a peripheral portion of the barrier such that a side of the peripheral portion of the barrier rests against a side wall 25 that is located in the recess 23. The peripheral portion includes a bent portion that substantially extends at right angles to the rest of the barrier. The bent portion of the barrier is received by a laterally extending portion 26 of the recess 23. An abutment 27 is received by a corner of the barrier that is defined by the intersection of the bent portion with the rest of the barrier.

The barrier is held in position relative to the frame 22 by a locking element (not depicted) that is received by the recess 23 such that the locking element is located between the barrier and a side wall 28 that is located on an opposite side of the recess 23 to the side wail 25. The side wall 28 includes serrations 29, and the locking element includes complementary serrations that engage with the serrations 29 so that the locking element is thereby inhibited from being withdrawn from the recess 23.

The debris screen assembly 20 also includes a support 40 that is in the form of a mounting frame 41. The mounting frame 41 supports the screen 21 and therefore the barrier of the screen 21. Although not shown in the figures, the mounting frame 41 will typically include a pair of laterally spaced and parallel horizontal elongate frame members and a pair of laterally spaced and parallel vertical elongate frame members that extend between and that are joined to the horizontal frame members so that the frame members form a rectangular perimeter that surrounds a central void of the mounting frame 41.

The mounting frame 41 includes a fixed part 42 that is attachable to a building such that the fixed part 42 surrounds a window or door of the building that is to be protected from object impacts by the debris screen assembly 20. The fixed part 42 includes a bottom wall 43 which is the portion of the fixed part 42 that is attachable to the building. A pair of laterally separated side walls 44 extends perpendicularly from the bottom wall 43 such that a channel 45 is defined between the side walls 44. Catches 46 are located at distal ends of the side walls 44 and extend outwardly therefrom.

In addition, the mounting frame 41 includes a moveable part 50 that is engageable with the fixed part 42 such that the moveable part 50 is able to slide relative to the fixed part 42 in a reciprocating manner. The moveable part 50 is configured so that when the fixed part 42 is attached to a building such that the fixed part 42 surrounds a window or door of the building that is to be protected by the debris screen assembly 20, the moveable part 50 will also surround the window or door. The moveable part 50 includes a bottom wall 51, and a pair of laterally separated side walls 52 extending perpendicularly from the bottom wall 51 such that a channel 53 is defined between the side walls 53. Catches 54 are located at distal ends of the side walls 52 and extend inwardly therefrom.

Each of the channels 45 and 53 extends around the perimeter of the mounting frame 41.

An elongate and resiliently compressible element 55 is received by and extends along the channel 45 of the fixed mounting frame part 42 such that the element 55 extends around the perimeter of the mounting frame 41. The resilient element 55 is part of a shock absorbing portion 56 of the mounting frame 41. The resilient element 55 ordinarily has a circular profile. The element 55 is compressed or flattened when it is inserted into the channel 45 as can be seen in FIG. 1 so that the profile of the element 55 consequently becomes elliptical. Roughly half of the resilient element 55 is inserted into the channel 45.

The side walls 44 of the fixed part 42 and the portion of the resilient element 55 that is not inserted into the channel 45 are inserted into the channel 53 of the moveable part 50. This is accomplished by bending the side walls 44 towards each other so that the resilient element 55 is further compressed between the side walls 44 and so that there is sufficient lateral clearance between the catches 46 and 54 to allow the side walls 44 to be inserted into the channel 53. Once the side walls 44 have been bent by a sufficient amount, they and the resilient element 55 are inserted into the channel 53 until the catches 46 are located inwardly of the catches 54. Inserting the side walls 44 into the channel 53 to this extent causes the resilient element 55 to be compressed between the bottom walls 43, 51. The side walls 44 are then released so that they return to their original position. The compressed resilient element 55 pushes against the bottom walls 43, 51 so that the side walls 44 are pushed out of the channel 53 until the catches 46. 54 engage with each other as shown in FIG. 2 and prevent further movement of the side walls 44 out of the channel 53.

The screen 21 is supported by the mounting frame 41 such that a flange 60 of the screen frame 22 rests against a flange 61 of the moveable mounting frame part 50. The flange 60 extends around the perimeter of the screen frame 22, and the flange 61 extends around the perimeter of the moveable mounting frame part 50.

The screen 21 is detachably secured to the mounting frame 41 by one or more latch mechanisms 70. Each latch mechanism 70 includes a catch 71 that extends from the flange 60 of the screen frame 22. In addition, each latch mechanism 70 includes a pivotable latch 72 that is hinged to the moveable mounting frame part 50 and that is able to engage with the catch 71 so as to prevent the screen 21 from being detached from the mounting frame 41. Latch 72 includes a hinge pin 73 that is received by a socket 74 of the moveable part 50 so that the latch 72 is able to be pivoted back and forth relative to the moveable part 50. A flange 75 of the of the moveable part 50 limits pivoting movement of the latch 72 towards the screen 21, and a flange 76 limits pivoting movement of the latch 72 away from the screen 21.

When the latch 72 is pivoted towards the screen 21 by the maximum extent so that the latch 72 abuts against the flange 75, an engagement portion 77 of the latch 72 engages with the catch 70 so that the screen 21 is thereby secured to the mounting frame 41. When the latch 72 is pivoted away from the screen 21 by the maximum extent so that the latch 72 abuts against the flange 76, the engagement portion 77 of the latch 72 is disengaged from the catch 71 so that the screen 21 is not secured to the mounting frame 41 by the latch mechanism 70. To pivot the latch 72 relative to the mounting frame 41, a user grasps a handle 78 of the latch 72 with one or both of their hands and then pivots the latch 72 in the appropriate direction to either engage the latch 72 with the catch 71, or to disengage the latch 72 from the catch 71.

The debris screen assembly 20 is attached to a building by attaching the fixed part of the mounting frame 41 to the building so that the mounting frame 41 extends around a window or door of the building and so that the screen 21 including its mesh barrier substantially covers the window or door. The assembly 20 is also attached to the building so that the shock absorbing portion 56 of the mounting frame 41 is located between the screen 21 and the building.

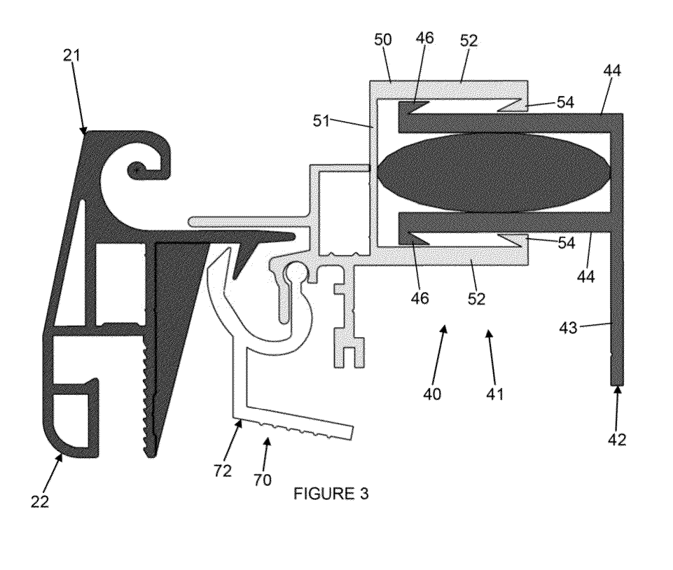

The mounting frame 41 and the screen 21 are arranged relative to the building so that if an airborne object hits the screen 21, the force of the impacting object will be transferred from the screen 21 to the moveable part 50 of the mounting frame 41. If the force transferred to the part 50 is of sufficient magnitude, the part 50 will slide along the fixed part 42 of the mounting frame 41 so that the resilient element 55 is compressed between the parts 42 and 50 as shown in FIG. 3. When the resilient element 55 is compressed in this way, at least some of the energy from the impacting object is stored in the element 55. Once the force exerted on the moveable part 50 is insufficient to continue moving the part 50 along the fixed part 42 so as to further compress the element 55 between the parts 42 and 50, the relative movement between the two parts 42, 50 ceases. Thus, the shock absorbing portion 56 of the mounting frame 41 which includes the resilient element 55 effectively absorbs at least some of the energy of the impacting object.

If the object does not continue to exert a sufficient amount of force on the screen 21 so as to maintain the resilient element 55 in compression, the energy stored in the element 55 will result in the energy stored in the element 55 being released so that the element 55 expands back to its pre-impact state. The expansion of the resilient element 55 back to its pre-impact state causes the moveable part 50 of the mounting frame 41 to slide back along the fixed part 42 in the opposite direction until the catches 46 and 54 once again engage with each other as depicted in FIG. 2.

The support 40 of the debris screen assembly 20 which is in the form of the mounting frame 41 is able to assist the screen 21 that includes the barrier secured to the screen frame 22 to withstand an impact from an object that has more energy than the screen 21 would be able to withstand in the absence of being supported by the support 40.

The support 40 of the debris screen assembly 20 is able to assist the screen assembly 20 to withstand an object impact having an energy of 4000 Joules so that the assembly 20 is able to comply with the impact load requirements specified in the amended Australian standard for cyclone debris screens.

At least the screen 21 of the debris screen assembly 20 which includes the barrier and the screen frame 22 may be hinged relative to the building to which the assembly 20 is attached so that the screen 21 is able to be pivoted relative to at least the building. Hinging the screen 21 relative to the building can make it easier to clean the screen 21 including its barrier, and can also make it easier for a person to enter or exit the building through the window or door that is protected by the assembly 20.

In other preferred embodiments, the screen frame 22 may include an energy absorbing portion so that the screen frame 22 is able to absorb energy from an object that impacts the screen 21.

The energy absorbing portion 56 does not necessarily need to include the resilient element 55. For example, instead of including the resilient element 55, the support absorbing portion 56 may include a crumple zone, or it may be collapsible.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

It will be clearly understood that, if a prior art publication is referred to herein, that reference does not constitute an admission that the publication forms part of the common general knowledge in the art in Australia or in any other country.

1. A support for supporting a barrier for covering an opening of a building, the support comprising a shock absorbing portion, the support being attachable relative to the building and also being able to support the barrier such that the barrier substantially covers the opening and such that the shock absorbing portion is able to absorb at least some of the energy of an object that impacts the barrier.

2. The support defined by claim 1, wherein the support comprises a frame.

3. The support defined by claim 2, wherein the support comprises a frame that is attachable relative to a window or door of the building.

4. The support defined by claim 2, wherein the support comprises a mounting frame for supporting a screen that includes the barrier.

5. The support defined by claim 2, wherein the support comprises a screen frame for holding the barrier.

6. The support defined by claim 1, wherein the support is attachable relative to the building such that the shock absorbing portion of the support is substantially located between the barrier and the building.

7. The support defined by claim 1, wherein the shock absorbing portion comprises a resilient element.

8. The support defined by claim 7, wherein the resilient element comprises a resilient tube or block.

9. The support defined by claim 7, wherein the shock absorbing portion comprises a crumple zone, or the shock absorbing portion is collapsible.

10. A method for protecting a building from an object impact, the method comprising the steps of:
supporting a barrier for covering an opening of the building with a support that comprises a shock absorbing portion; and
attaching the support relative to the building such that the supported barrier substantially covers the opening and such that the shock absorbing portion is able to absorb at least some of the energy of an object that impacts the barrier.

11. A debris screen assembly for protecting a building from an object impact, the assembly comprising a barrier for covering an opening of the building, and a support that supports the barrier, the support comprising a shock absorbing portion, the support being attachable to the building such that the barrier substantially covers the opening and such that the shock absorbing portion is able to absorb at least some of the energy of an object that impacts the barrier.

12. The debris screen assembly defined by claim 11, wherein the support comprises a mounting frame.

13. The debris screen assembly defined by claim 11, wherein the screen assembly also comprises a screen that comprises the barrier and a screen frame that holds the barrier.

14. The debris screen assembly defined by claim 11, wherein the debris screen assembly also comprises a latch mechanism that secures the screen to the mounting frame.

15. The debris screen assembly defined by claim 11, wherein the barrier comprises mesh.

16. The debris screen assembly defined by claim 15, wherein the mesh comprises wire mesh,

17. The debris screen assembly defined by claim 11, wherein at least the barrier is able to be hinged relative to the building.

18. (canceled)
